(19) United States
(12) Patent Application Publication
(10) Pub. No.: US 2012/0327931 A1
(43) Pub. Date: Dec. 27, 2012

(54) GATEWAYS INTEGRATING NAME-BASED NETWORKS WITH HOST-BASED NETWORKS

(75) Inventors: Jario O. Esteban, Freehold, NJ (US); Andre Beck, Batavia, IL (US); Steven A. Benno, Towaco, NJ (US); Volker F. Hilt, Middletown, NJ (US); Ivica Rimac, Offenbach (DE); Matteo Varvello, Port Monmouth, NJ (US)

(73) Assignee: ALCATEL-LUCENT USA INC., Murray Hill, NJ (US)

(21) Appl. No.: 13/165,243

(22) Filed: Jun. 21, 2011

(51) Int. Cl. H04L 12/56

(52) U.S. Cl. 370/389

(57) ABSTRACT

A method of retrieving content from a network with a host-based network and a name-based network includes receiving, at a network node, a first message including at least one of a first host-based request and a first name-based interest, and transmitting, from the network node, a second message based on the at least one of the first host-based request and the first name-based interest.

### BACKGROUND

1. Field

Example embodiments relate to name-based and host-based networks.

2. Description of the Related Art

The Internet is a global system of interconnected computer networks that use a standard Internet Protocol Suite (TCP/IP). The internet and conventional networks connected to the internet are typically connection oriented and establish communications between two specific machines (e.g., host-based networking). In order to communicate, two hosts exchange internet protocol (IP) packets carrying data. The IP packets contain two addresses, one for the source machine and one for the destination machine. For this reason, each machine that is connected directly to the internet must have a unique address.

In addition to the addresses of the source and destination machines, a port number identifying a specific application on the destination machine is included in the packet. A Transmission Control Protocol (TCP) is responsible for routing packets to correct applications on the destination machine using the port numbers. TCP is a connection oriented, reliable, byte stream service and requires a connection between applications before sending data.

Once a packet includes a port number (e.g., in a TCP header) and the addresses of the source and destination machines, the packets are transmitted by a hardware layer. Generally, there are multiple nodes between the source and destination machine. When a packet arrives at a node, it is inspected to determine the destination address of the packet and the packet is forwarded using a routing table.

One of the services used on the internet is the World Wide Web (WWW). The application protocol used to communicate over the WWW is the Hypertext Transfer Protocol (HTTP). HTTP allows specific applications, such as web browsers and web servers, to communicate through HTTP sessions. For example, a web browser may establish a connection to a destination machine and then send an HTTP request for a desired web page.

Packets may contain information other than IP addresses to identify the source and destination machines. For example, the packet may be sent with domain names instead of IP addresses, such as domain names in Uniform Resource Locators (URLs). In this case, a node uses a domain name service (DNS) to lookup the IP address of the corresponding machine based on the domain names.

Opening an HTTP session implies a network connection to a named device. On the other hand, accessing a URL only implies that its associated data is made available. While HTTP is inherently connection-oriented, a URL is inherently data-oriented. For example, a user requesting data using a URL may receive a locally cached copy of the data without any connection having been established to a destination machine. The use of URLs may be seen as a move away from a connection oriented network model towards a data oriented model.

Although connections between specific machines on the internet are necessary in some cases (e.g., a telephone call), often a user is interested in retrieving specific data but does not necessarily care where the data comes from. For example, a user may wish to hear the latest song produced by a particular musical artist, but does not care from what machine the song is received. Accordingly, what-not-where networking models have been proposed in which requests specify data and are not required to specify a host that stores a copy of the data. In so called name-based networks, a request for specific data is provided into the network and the network is responsible for retrieving the data.

### SUMMARY

At least one example embodiment includes a method of retrieving content from a network, the method including receiving, at a network node, a first message with at least one of a first host-based request and a first name-based interest, and transmitting, from the network node, a second message based on the at least one of the first host-based request and the first name-based interest.

At least one example embodiment includes a network with a network node configured to receive a name-based interests and host-based requests from a plurality of requesting nodes, to retrieve data from name-based and host-based networks in response to the interests and requests, and to transmit host-name responses and name-based data messages to the requesting nodes.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 is a block diagram illustrating a network including a network node according to example embodiments; and

FIGS. 2-4 are flowcharts illustrating methods of retrieving content from a network according to example embodiments.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

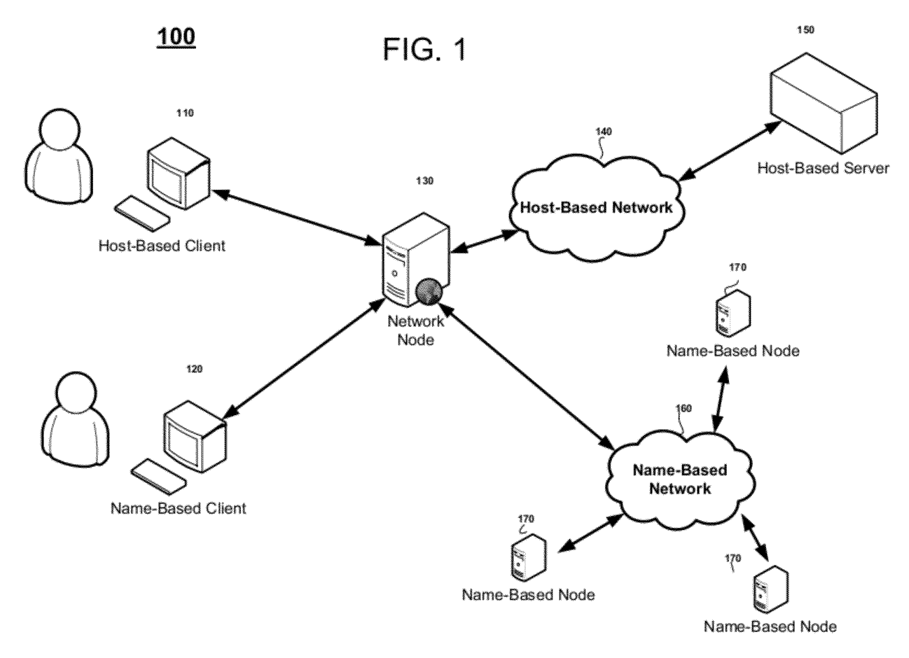

FIG. 1 is a block diagram illustrating a network 100 including a network node 130 according to example embodiments. Referring to FIG. 1, a network 100 may include a host-based client 110, a name-based client 120, a network node 130, a host-based network 140, a host-based server 150, a name-based network 160 and name-based nodes 170. The host-based client 110 may be, for example, a Hypertext Protocol (HTTP) client communicating with the network node 130 using the HTTP protocol to send host-based requests (e.g., HTTP requests) for content. The name-based client 120 may be, for example, a client communicating with the network node 130 using name-based interests to request uniquely identifiable content. It is noted that while requests may be name-based or host-based, clients are not necessarily host- or name-based according to example embodiments.

The host-based network 140 may be, for example, an IP network (e.g., the internet). The host-based server 150 may be, for example, a web server that communicates using the HTTP protocol. The name-based network 160 may be, for example, a network that communicates using name-based interests and name-based data messages. The name-based nodes 170 may be, for example, name-based servers that send name-based data in response to name-based interests. The host-based network 140 may be, for example, an Internet Protocol (IP) network routing packets according to IP addresses contained in the packets. For example, a node in the host-based network 140 may inspect the IP header of the packet to determine the IP address of the destination machine to which the packet is to be sent.

According to a non-limiting example, a name-based interest may be a message sent from a client machine requesting a map of a zone in which the user is standing at the present time. For example, the object being requested may be an image file, identified by its name “localMap”. According to another non-limiting example, a name-based interest may be a message sent by a client machine requesting the trailer of an upcoming movie. For example, the object being requested may be a video file, identified by the name of the clip, “[moviename]MovieClip” (e.g., where the name of a movie replaces “[moviename]”).

The name based interests may correspond to interests expressed by the clients. Typical fields that may be part of the interest messages may include: Timestamp, Unique message id, object name, time-to-live, and expiration timestamp. According to example embodiments, the object name does not necessarily point to a specific host machine that serves the requested content. Instead, the object name identifies the object by its name. The response messages that correspond to the interest messages described above may include, for example, the object itself (image, video), the unique message id for the original interest, and a checksum.

In a host-based network it is necessary to couple the location (host machine) with the name of an object in order to retrieve the object. The host machine is necessary for the network to route the message. A name-based network only requires the name of the object being requested in order to route the message.

The network node 130 may be, for example, an HTTP proxy. HTTP proxies are ubiquitous in host-based networks and may serve different purposes, from caching to filtering, to anonymizing. Example embodiments include an architecture in which HTTP proxies may be augmented to direct a subset of selected requests to a name-based network. Although example embodiments are described with reference to an HTTP proxy, example embodiments are not limited thereto.

The network node 130 may receive host-based content requests from host-based clients and name-based interests from name-based clients. Selected content requests may be resolved by the network node 130 using either the host-based network 140 or the name-based network 160. For example, the network node 130 may attempt to resolve an interest/request using the name-based network 160 in the first instance, and if the name-based network fails to satisfy the interest/request, the network node 130 may attempt to resolve the requests/interests using the host-based network 140.

According to at least one other example embodiment, the network node 130 may attempt to resolve a name-based interest or name-based request using both of the host-based network 140 and the name-based network 160 simultaneously. According to at least one further example embodiment, the network node 130 may attempt to resolve requests/interests using the host-based network 160 in the first instance.

According to at least one example embodiment, the network node 130 may apply filtering rules to each interest or request to determine which of the name-based network 160 and the host-based network 140 will initially be requested to resolve the interest or request. For example, the network node 130 may select which host-based requests will be attempted to be resolved by the name-based network 160 by applying filtering rules to each host-based request.

The filtering rules may be, for example, represented in the form of Regular Expressions. The filtering rules may be represented by any mechanism that can be applied to all or part of the host-based request, for example, to a Uniform Resource Locator (URL) and/or HTTP header of the host-based request. A filtering rule may be a regular expression that can be applied to the request URL, for example, http://.*\.png, which matches all URLs requesting PNG image files.

Filtering rules may be stored locally and/or be distributed. The filtering rules may be fed to the network node 130 manually and/or may be created automatically as the knowledge base of the network node 130 and other elements in the network with respect to content requests increases. The rules may reflect the subset of requests that can be served at any given time using the name-based network 160.

The network node 130 may convert host-based requests into name-based interests and host-based responses into name-based data using conversion rules. The network node 130 may convert name-based interests into host-based requests and name-based data into host-based responses using reverse conversion rules.

An example of a simple conversion rule from host-based URL to name-based interest may include removing the leading “http:/ /” string from the URL and escaping all the non-digit and non-letter characters in order to obtain the resulting object identifier for the name-based network. Conversely, given a name-based object identifier, the reverse conversion rule may prepend the string http:/ /. More complex conversion rules can remove, for example, one or more arguments from the URL.

For example, at such time as the network node 130 attempts to resolve a host-based request from a host-based client 110 using the name-based network 160, the network node 130 may apply conversion rules and generate a name-based interest based on the host-based request. The generated name-based interest may be transmitted to the name-based network 160 for resolution. The network-node 130 may receive name-based data from the name-based network 160 in response to the name-based interest and apply reverse conversion rules to generate a host-based response. The generated host-based response may be transmitted to the host-based client 110.

At such time as the network node 130 attempts to resolve a name-based request from a name-based client 120 using the host-based network 140, the network node 130 may apply reverse conversion rules and generate a host-based request based on the name-based interest. The generated host-based request may be transmitted to the host-based network 140 for resolution. The network-node 130 may receive a host-based response from the host-based network 140 in response to the host-based request and apply conversion rules to generate name-based data. The generated name-based data may be transmitted to the name-based client 120.

Conversion rules and reverse conversion rules may utilize a mapping between a host-based request and a name-based interest. For example, conversion and reverse-conversion rules may utilize a mapping between an HTTP request and uniquely named content that can be resolved by the name-based network. These conversion and reverse conversion rules may be, for example, in the form of Regular Expressions, and may be stored locally and/or distributed. The conversion rules may be created manually and/or dynamically by network components.

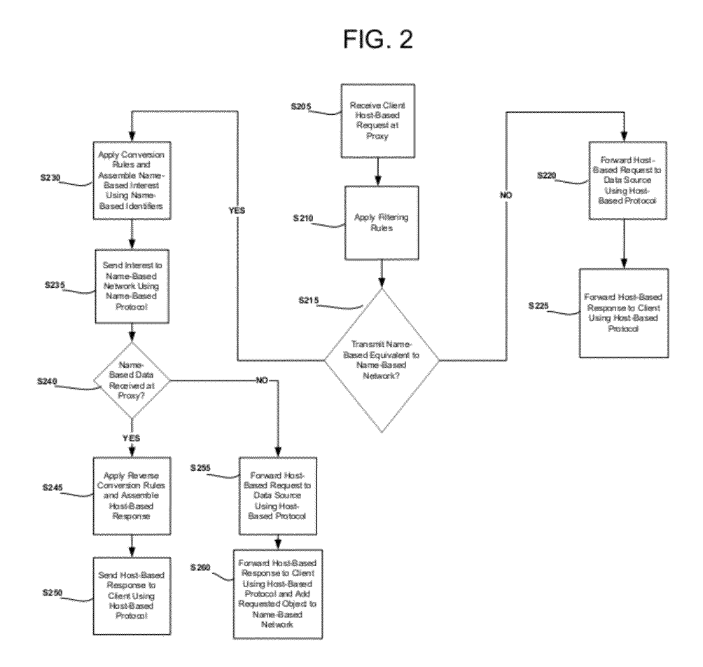

FIG. 2 is a flowchart illustrating methods of retrieving content according to an example embodiment. Referring to FIG. 2, a host-based request may be received by the network node 130 from the host-based client 110 (S205). The network node 130 may apply filtering rules to determine if an attempt will be made to resolve the host-based request in the first instance by the name-based network 160 (S210).

If the result of the applying of the filtering rules (S215) is that an attempt will be made to resolve the host-based request using the name-based network 160 in the first instance, conversion rules may be applied to the host-based request (S230). The conversion rules may be used to assemble a name-based interest using name-based identifiers. Once the name-based interest is assembled, the network node 130 may transmit the name-based interest to the name-based network 160 using a name-based protocol (S235).

The network node 130 may wait a period of time to receive name-based data from the name-based network 160. If the name-based data is received within the period of time (S240), the network node 130 may apply reverse conversion rules to convert the name-based data into a host-based response (S245). The host-based response may be assembled and transmitted to the host-based client 110 (S250). If name-based data is not received within the period of time (S240), the network node 130 may forward the host-based request received from the host-based client 110 to the data source addressed in the host-based request. The host-based request may be forwarded via the host-based network 140 using a host-based protocol (S255).

Upon receiving a host-based response from the host-based network 160, the host-based response may be forwarded to the host-based client 110. The requested object (e.g., requested content) may be added to one or more of the name-based nodes 170 in the name-based network 160 such that any future request may be resolved by the name-based network 160 (S260).

Although not illustrated, if the network node 130 receives name-based data from the name-based network 160 after a host-based request is forwarded (S255) but before a host-based response is received (S260), the name-based data may be converted to a host-based response and transmitted to the host-based client 110 (S245 and S250). The network node 130 may forward any host-based response received from the host-based network 140 or may discard the received host-based response. The network node 130 may also cancel the outstanding request to the host-based network, for example by closing the connection to the host-based server. This may be similar to sending a byte-range request in that it minimizes and/or reduces the transmission of duplicate data.

Upon applying the filtering rules (S210) to the host-based request, the network node 130 may determine that an attempt will not be made to resolve the host-based request using the name-based network 160 in the first instance (S215). In that case, the network node 130 may forward the host-based request to the content source addressed in the host-based request. The host-based request may be forwarded via the host-based network 140 using a host-based protocol (S220). Upon receiving a host-based response from the host-based network 160, the host-based response may be forwarded to the host-based client 110 (S225).

According to a non-limiting example of example embodiments described with respect to FIG. 2, the host-based client 110 (e.g., an HTTP client) may retrieve a web page from a portal. The web page may have multiple embedded objects. For example, one of the objects may correspond to a background image. Each of the embedded objects may be identified by a URL. In order to render the web page, the host-based client 110 may request all of the objects using the HTTP protocol. The host-based requests may reach the network node 130 (e.g., an HTTP proxy). The network node 130 may apply filtering rules to all of the host-based requests to determine which of the host-based requests will be tried first on the name-based network 160.

The network node 130 may apply the conversion rules to determine name-based identifiers equivalent to the objects requested in the host-based request. Using the name-based identifiers, the network node 130 may signal the name-based network 160 its interest in retrieving the objects. For those objects that may be retrieved from the name-based network 160, the network node 130 may assemble a host-based response (e.g., an HTTP response message) according to reverse conversion rules. For the objects that cannot be retrieved from the name-based network 160, the network node 130 may forward the host-based request to the addressed host-based server 150 using the HTTP protocol and the host-based infrastructure. If the host-based server 150 replies successfully, the network node 130 may forward the response to the client, and additionally may ingest the object that was retrieved to the name-based network 160.

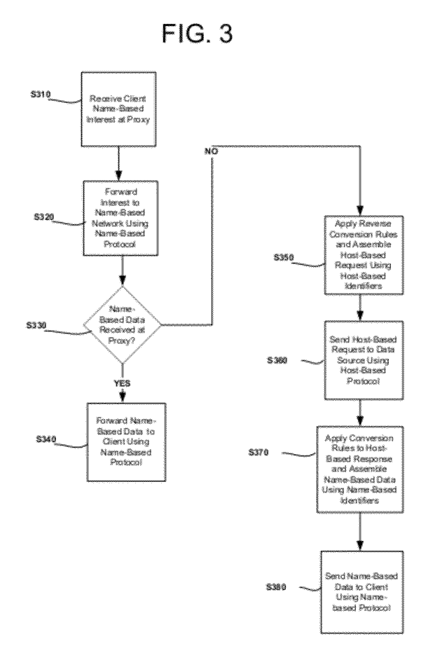

FIG. 3, is a flowchart illustrating methods of retrieving content according to another example embodiment. Referring to FIG. 3, a name-based interest may be received by the network node 130 from the name-based client 120 or the host-based client 110 (S310). The network node 130 may forward the name-based interest to the name-based network 160 using a name-based protocol (S320). The network node 130 may wait a period of time to receive name-based data from the name-based network 160 in response to the name-based interest. If the network node 130 receives the name-based data within the period of time (S330), the name-based data may be forwarded to the name-based client 120 or the host-based client 110 using a name-based protocol.

If the name-based data is not received within the period of time (S330), the network node 130 may apply reverse conversion rules (S350) and assemble a host-based request using host-based identifiers (S350). The assembled host-based request may be forwarded by the network node 130 to the host-based server 150 addressed by the host-based request. The host-based request may be forwarded via the host-based network 140 using a host-based protocol (S360). Upon receiving a host-based response to the host-based request, the network node 130 may apply conversion rules to the host-based response and assemble name-based data using name-based identifiers (S370). The network node 130 may transmit the assembled name-based data to the name-based client 120 or the host-based client 110 using a name-based protocol (S380).

According to a non-limiting example of example embodiments described with respect to FIG. 3, a name-based client 120 or a host-based client 110 may retrieve a web page from a portal. The web page may contain element identifiers in a name-based nomenclature. For example, one of the elements in the web page may refer to a service which identifies a TV screen located in the same room as the client. In this case, neither filtering rules nor conversion rules are applied, and the network node 130 (e.g., a proxy) may directly use the name-based infrastructure to signal an interest in the named elements and retrieve the named elements. If the named elements are successfully retrieved, the response may be sent to the client according to the protocol used to make the request. If the named element is not successfully retrieved, the network node 130 may apply reverse conversion rules to transform the name-based identifier into a host-based identifier and attempt to fulfill the request using the host-based (e.g., HTTP) infrastructure.

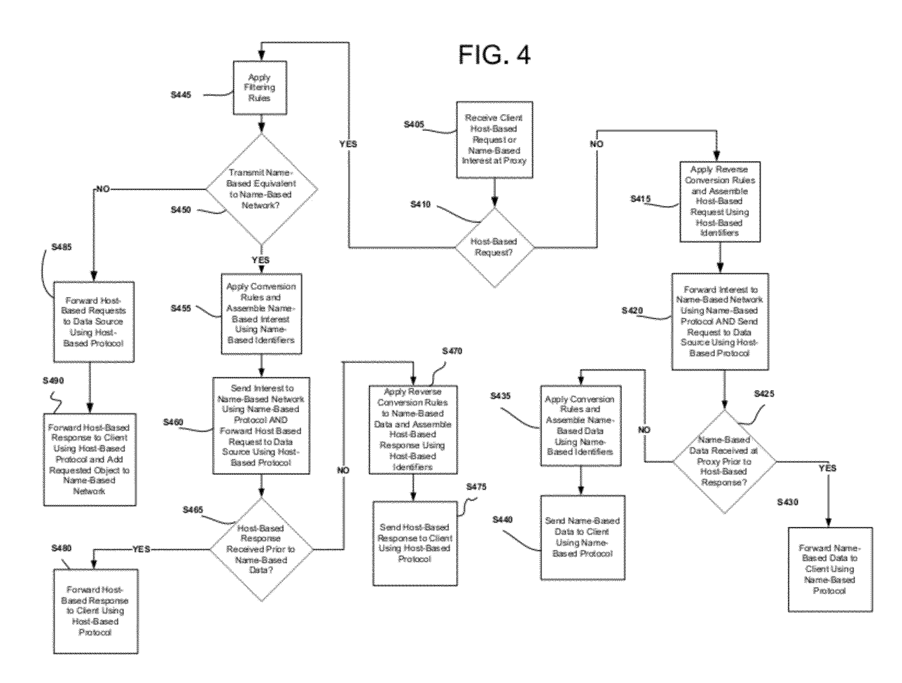

FIG. 4, is a flowchart illustrating methods of retrieving content according to yet another example embodiment. Referring to FIG. 4, one of a host-based request and a name-based interest is received by a network node 130 from one of the host-based client 110 and the name-based client 120 (S405). If the received message is a host-based request (S410), the network node 130 may apply filtering rules to determine if an attempt will be made to resolve the host-based request in the first instance by the name-based network 160 (S445).

If the result of the applying of the filtering rules is that an attempt will be made to resolve the host-based request using the name-based network 160 (S450), conversion rules may be applied to the host-based request. The conversion rules may be used to assemble a name-based interest using name-based identifiers (S455). Once the name-based interest is assembled, the network node 130 may transmit the name-based interest to the name-based network 160 using a name-based protocol. The network node 130 may forward the host-based request to the data source addressed in the host-based request either before, at the same time, or after the name-based interest is assembled (S460).

If a host-based response is received by the network node 130 from the host-based network 140 prior to receiving name-based data from the name-based network 160, the host-based response may be forwarded to the one of the host-based client 110 and the name-based client 120 requesting content (S480). The host-based response may be transmitted using a host-based protocol. If a name-based response is received by the network node 130 from the name-based network 160 prior to receiving a host-based response from the host-based network 140, the network node 130 may apply reverse conversion rules to the named-based data and assemble a host-based response using host-based identifiers (S470). The host-based response may be transmitted to the one of the host-based client 110 and the name-based client 120 requesting content (S475). The host-based response may be transmitted using a host-based protocol.

If the result of the applying of the filtering rules (S450) is that an attempt will not be made to resolve the host-based request using the name-based network 160, the network node 130 may forward the host-based request to the host-based server 150 addressed in the host-based request. The host base request may be forwarded via the host-based network 140 using a host-based protocol (S485). Upon receiving a host-based response from the host-based network 160, the host-based response may be forwarded to the one of the host-based client 110 and the name-based client 120 requesting content. The requested object (e.g., requested content) may be added to one or more of the name-based nodes 170 in the name-based network 160 such that any future request may be resolved by the name-based network 160 (S490).

If a name-based request is received by the network node 130 (S410), the network node 130 may apply reverse conversion rules (S415) and assemble a host-based request using host-based identifiers (S415). Once the host-based request is assembled, the network node 130 may transmit the host-based request to the host-based network 140 using a host-based protocol (S420). The network node 130 may forward the name-based interest to the name-based network 160 either before, at the same time, or after the name-based interest is assembled (S420). The name-based interest may be forwarded using a name-based protocol.

If name-based data is received by the network node 130 from the name-based network 160 prior to receiving a host-based response from the host-based network 140, the name-based data may be forwarded to the one of the host-based client 110 and the name-based client 120 requesting content (S430). The name-based response may be transmitted using a name-based protocol. If a host-based response is received by the network node 130 from the host-based network 140 prior to receiving name-based data from the name-based network 160, the network node 130 may apply conversion rules to the host-based response and assemble name-based data using name-based identifiers (S435). The name-based data may be transmitted to the one of the host-based client 110 and the name-based client 120 requesting content (S440). The name-based response may be transmitted using a name-based protocol.

According to a non-limiting example of example embodiments described with respect to FIG. 4, a request for content that reaches the network node 130 may be multiplexed to both the name-based network 160 and the host-based network 140 regardless of the nomenclature used in the content request. The network node 130 may respond to the requesting client utilizing whichever response arrives first.

If the original content request uses host-based nomenclature, the network node 130 may apply filtering rules in order to determine if the request will also be sent to the name-based network 160. Conversion rules may be applied to determine the equivalent name-based identifier. If the original content request uses name-based nomenclature, the network node 130 may apply reverse conversion rules to determine the corresponding host-based identifier.

According to example embodiments, the host-based request may be a byte-range request in order to minimize and/or reduce the amount of duplicate data that is received if the requested content is available in both networks. If name-based data arrives from the name-based network 160 prior to receiving host-based data from the host-based network 140, the network node 130 may discard any byte-range response it receives from the host-based network. If the host-based response arrives from the host-based network 140 prior to receiving name-based data from the name-based network 160, the network node 130 may request the complete object from the host-based network. The host-based response received in response to the request for the complete object may be transmitted to the requesting client. According to other example embodiments, the object received from the host-based network may be stored in the name-based network.

According to example embodiments, name-based networks may be integrated with host-based networks using gateways. The integration may be gradual. Content may be copied to the name-based networks when a request is made but not satisfied by the name-based networks, and is provided by a host-based network. As a knowledge base regarding content requests increases, more rules may be generated and more content may be served from the name-based network. Requests that cannot be satisfied by a name-based network may still be satisfied by the host-based infrastructure. For example, requests for dynamic content, not-cacheable objects and those requests that may not be analyzed under the existing rule set, may be provided by a host-based server.

According to example embodiments, the use of name-based networks may be transparent to clients requesting data and to host-based networks. Regardless of the mechanism utilized to retrieve content, the requestor may receive a reply which is compliant to the protocol used to submit the request.

While example embodiments have been particularly shown and described, it will be understood by one of ordinary skill in the art that variations in form and detail may be made therein without departing from the spirit and scope of the claims.

What is claimed is:

1. A method of retrieving content from a network, the method comprising:
receiving, at a network node, a first message including at least one of a first host-based request and a first name-based interest; and
transmitting, from the network node, a second message based on the at least one of the first host-based request and the first name-based interest.

2. The method of claim 1, wherein the first message includes the first host-based request,
the first host-based request is received from a requesting node, and
the second message is different from the first message.

3. The method of claim 2, further comprising:
applying filtering rules to determine if a second name-based interest corresponding to the first host-based request will be transmitted to a name-based network; and
upon determining that the second name-based interest will be transmitted to a name-based network:
applying conversion rules to the first host-based request to determine the second name-based interest; and
assembling the second name-based interest, the second message including the second name-based interest,
wherein the transmitting a second message includes transmitting the second message to the name-based network.

4. The method of claim 3, further comprising:
receiving, at the network node, a name-based data message in response to the second message;
applying reverse conversion rules to the name-based data message to determine a host-based response;
assembling the host-based response based on the applying reverse conversion rules; and
transmitting the host-based response to the requesting node.

5. The method of claim 1, wherein the first message includes the first name-based interest,
the first name-based interest is received from a requesting node, and
the transmitting a second message includes transmitting the first name-based interest to a name-based network.

6. The method of claim 5, further comprising:
determining, by the network node, that a time period has elapsed without receiving a name-based data message from the name-based network;
applying reverse conversion rules to the name-based interest to determine a second host-based request;
assembling the second host-based request; and
transmitting the second host-based request to a host-based network.

7. The method of claim 6, further comprising:
receiving a host-based response to the host-based request;
applying conversion rules to the host-based response to determine a name-based data message;
assembling the name-based data message; and
transmitting the name-based data message to the requesting node.

8. The method of claim 3, further comprising:
transmitting a third message including the first host-based request to a host-based network.

9. The method of claim 8, further comprising:
receiving, at the network node, a name-based data message in response to the second message prior to receiving a first host-based response to the third message;
applying reverse conversion rules to the name-based data message to determine a second host-based response;
assembling the second host-based response based on the applying reverse conversion rules; and
transmitting the second host-based response from the network node.

10. The method of claim 5, further comprising:
applying reverse conversion rules to the first name-based interest to determine a second host-based request;
assembling the second host-based request; and
transmitting a third message including the second host-based request to a host-based network.

11. The method of claim 10, further comprising:
receiving, at the network node, a host-based response to the third message prior to receiving a first name-based data message in response to the second message;
applying conversion rules to the host-based response to determine a second name-based data message;
assembling the second name-based data message based on the applying conversion rules; and
transmitting the second name-based data message to a requesting node.

12. The method of claim 10, wherein the second host-based request is a byte-range request.

13. The method of claim 4, wherein the requesting node is a client.

14. The method of claim 2, further comprising:
applying filtering rules to determine if a second name-based interest corresponding to the first host-based request will be transmitted to a name-based network; and
upon determining that the second name-based interest will not be transmitted to the name based network:
forwarding the first host-based request to a host-based network;
receiving a host-based response to the first host-based request;
transmitting the host-based response from the network node to the requesting node; and
transmitting a copy of a data object included in the host-based response to the name-based network.

15. The method of claim 3, wherein the applying filtering rules includes using Regular Expressions.

16. The method of claim 3, wherein the applying conversion rules includes mapping the first host-based request to a unique name resolvable by the name-based network.

17. A network, comprising:
a network node configured to receive a name-based interests and host-based requests from a plurality of requesting nodes, to retrieve data from name-based and host-based networks in response to the interests and requests, and to transmit host-name responses and name-based data messages to the requesting nodes.

18. The network of claim 17, wherein the network node is configured to apply filtering rules in order to determine if one of the host-based requests will be at least one of transmitted to a host-based network and converted into a name-based interest and transmitted to a name-based network, and
the network node is configured to, upon determining that the one of the first-host based requests will be converted, to apply conversion rules and convert the one of the host-based requests into the name-based interest.

19. The network of claim 18, wherein the filtering rules are based on a subset of requests serviceable by the name-based network.

20. The network of claim 17, wherein the network node is a proxy server.
